(19) United States
(12) Patent Application Publication
(10) Pub. No.: US 2011/0307802 A1
(43) Pub. Date: Dec. 15, 2011

(54) REVIEW OF REQUESTS TO MODIFY CONTEXTUAL DATA OF A PROGRAMMING INTERFACE

(76) Inventor: Shreyank Gupta, Pune (IN)

(21) Appl. No.: 12/813,318

(22) Filed: Jun. 10, 2010

(51) Int. Cl. G06F 3/01

(52) U.S. Cl. 715/751; 715/760

(57) ABSTRACT

Some embodiments of a system and a method to review contextual data of programming interfaces have been presented. For instance, a processing device may generate a user interface to collect feedback from a group of reviewers on a programming interface in response to a request to modify contextual data of the programming interface. The processing device then consolidates the feedback to evaluate the feedback. Based on the feedback, the processing device determines whether to modify the contextual data of the programming interface as requested.

### TECHNICAL FIELD

Embodiments of the present invention relate to quality control of software, and more specifically to reviewing change requests on contextual data of programming interfaces.

### BACKGROUND

Conventionally, many software applications (or simply referred to as applications) use application binary interfaces (ABI), which are also generally referred to as programming interfaces. Programming interfaces typically have associated contextual data, which is a specific property of data, such as the level of importance of a programming interface based on requirements and feedback from users. Users of programming interfaces may request certain contextual data associated with the programming interfaces be changed.

Currently, providers of programming interfaces implement various protocols for making changes to contextual data of programming interfaces. In general, these conventional protocols involve manual review by one or more technical staff members of the providers to determine if the requested change is warranted. If so, the change to the contextual data of the programming interfaces requested will be made. However, there are many drawbacks of such a review process.

One drawback of the conventional manual review process is the lack of coordination between people who review the requests (a.k.a. the “reviewers”). Because each reviewer may log on to the system to review a request at different time and at different location, one reviewer may not be aware that another reviewer has already reviewed and provided feedback on the request. Thus, the reviewer may waste his time to review the request if the other reviewer has already determined that the request should be denied.

A second drawback of the conventional manual review process is not being user-friendly, and is a time-consuming process for reviewers. Typically, a reviewer has to manually pull a request submitted, and find the relevant programming interface. Thus, the reviewer may have to spend some time to locate and retrieve the request and the relevant programming interface before the reviewer can start substantive review of the request.

### BRIEF DESCRIPTION OF THE DRAWINGS

The present invention is illustrated by way of example, and not by way of limitation, in the figures of the accompanying drawings and in which:

FIG. 1 illustrates one embodiment of a system for reviewing contextual data change requests.

FIG. 2 illustrates a workflow diagram of one embodiment of a method to review contextual data change requests.

FIG. 3 illustrates a flow diagram of one embodiment of a method to provide an interface between reviewers and a defect tracking store.

FIG. 4 illustrates a block diagram of one embodiment of a server usable to review requests to modify contextual data of programming interfaces in some embodiments.

### DETAILED DESCRIPTION

Described herein are some embodiments of a method, an apparatus, and a system to review request to modify contextual data of programming interface. As used herein, a programming interface broadly refers to a application binary interface (ABI). In some embodiments, a processing device may generate a user interface to collect feedback from a group of reviewers on a programming interface in response to a request to modify contextual data of the programming interface. The processing device then consolidates the feedback to evaluate the feedback. Based on the feedback, the processing device determines whether to modify the contextual data of the programming interface as requested. Details of some embodiments of a tool for reviewing change requests on contextual data of programming interface are described below.

In the following description, numerous details are set forth. It will be apparent, however, to one skilled in the art, that the present invention may be practiced without these specific details. In some instances, well-known structures and devices are shown in block diagram form, rather than in detail, in order to avoid obscuring the present invention.

Some portions of the detailed descriptions below are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “collecting” or “consolidating” or “evaluating” or “approving” or “rejecting” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission, or display devices.

The present invention also relates to apparatus for performing the operations herein. This apparatus may be specially constructed for the required purposes, or it may comprise a general-purpose computer selectively activated or reconfigured by a computer program stored in the computer. Such a computer program may be stored in a machine-readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general-purpose systems may be used with programs in accordance with the teachings herein, or it may prove convenient to construct more specialized apparatus to perform the required operations. The required structure for a variety of these systems will appear from the description below. In addition, the present invention is not described with reference to any particular programming language. It will be appreciated that a variety of programming languages may be used to implement the teachings of the invention as described herein.

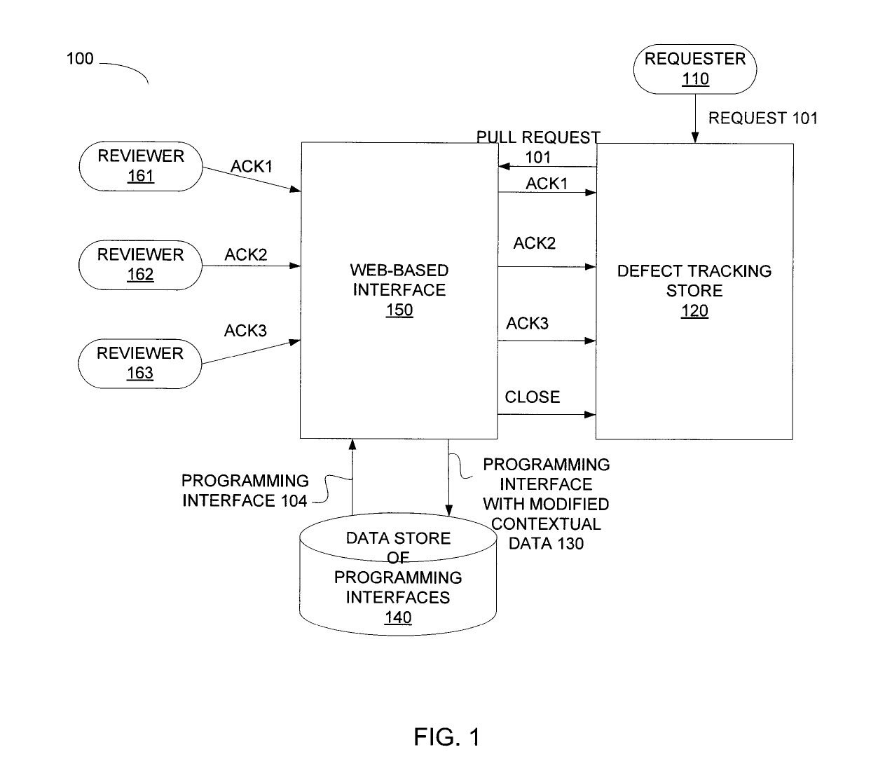

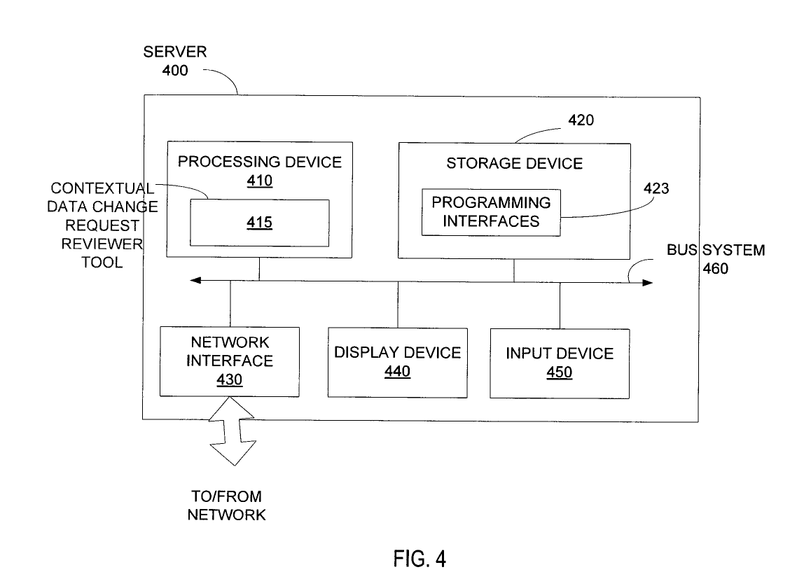

FIG. 1 illustrates one embodiment of a system for reviewing contextual data change requests. The system 100 includes a web-based interface 150, a defect tracking store 120, and a data store of programming interfaces 140. All or part of the system 100 may be implemented on one or more computing machines, such as a server, a desktop personal computer, a laptop computer, a personal digital assistant, etc. Details of one example of a server usable to implement the system 100 are illustrated in FIG. 4. The web-based interface 150, the defect tracking store 120, and the data store of programming interfaces 140 are communicably coupled to each other via a bus system within a computing machine and/or via a network, such as, for example, a public network (e.g., the Internet), a private network (e.g., a local area network), a wireless network, a wire-lined network, etc.

Generally speaking, the data store of programming interfaces 140 stores a set of programming interfaces that needs to be analyzed and possibly, modified. Changing of contextual data of programming interfaces may also be referred to as tagging the programming interfaces hereinafter. Since the set of programming interfaces is unusually large, there needs to be defined a workflow policy, or simply referred to as a policy, of tag-on-request basis. To request a change to the contextual data of one or more of the programming interfaces in the data store 140, a user may enter his/her request to the defect tracking store 120. The defect tracking store 120 is generally a quality control application to track defects in computer programs and/or software, reported by users. For example, the defect tracking store 120 may record the issues reported by users, dates and times the issues are reported, dates and times the issues are reviewed, names of people (e.g., technical staff members) who review the issues (hereinafter, the reviewers), results of review, etc. Instead of directly retrieving requests to modify contextual data from the defect tracking store 120, the reviewers, such as reviewers 161-163, use the web-based interface 150 to interface with the defect tracking store 120 instead. The reviewers 161-163 may include personnel such as, for example, product managers, software developers, quality assurance team members, etc.

In some embodiments, the web-based interface 150 includes a graphical user interface (GUI) rendered by a network access application, such as Windows® Internet Explorer® from Microsoft Corporation, Firefox from Mozilla Corporation, etc., which may run remotely on another computing machine. The system 100 may be communicably coupled to the other computing machine via a network, which may include the Internet, a local area network (LAN), an Ethernet, etc. Thus, the interface 150 is referred to as “web-based.” One advantage of the web-based interface 150 is that multiple reviewers can access the web-based interface 150 substantially simultaneously at the same or different locations. As such, feedback made by reviewers can be readily collaborated using the web-based interface 150. Furthermore, the GUI of the web-based interface 150 may provide a user-friendly interface, which may include simple user-friendly user interface control (e.g., checkboxes, buttons, scroll bars, etc.), to the reviewers.

After a requester 110 has submitted a request 101 to modify contextual data of a programming interface, the request 101 is stored in the defect tracking store 120. When a reviewer is ready to review the request 101, the reviewer may access the web-based interface 150, which may pull the request 101 from the defect tracking store 120 and display the request 101 via the GUI. In addition, the web-based interface 150 may retrieve the programming interface 104 from the data store 140 and displays the programming interface 104 via the GUI as well. Using the GUI, the reviewers 161-163 can easily review the request 101 and the programming interface 104 in order to decide if the request 101 to modify the contextual data of the programming interface 104 should be approved or rejected. After making a decision, each of the reviewers 161-163 may enter his/her feedback, which may include a flag indicating a positive acknowledgement or a negative acknowledgement, the role of the respective reviewer (e.g., a quality assurance team member, a product manager, a software developer, etc.), and/or reasoning behind his/her decision, etc., into the web-based interface 150 via the GUI.

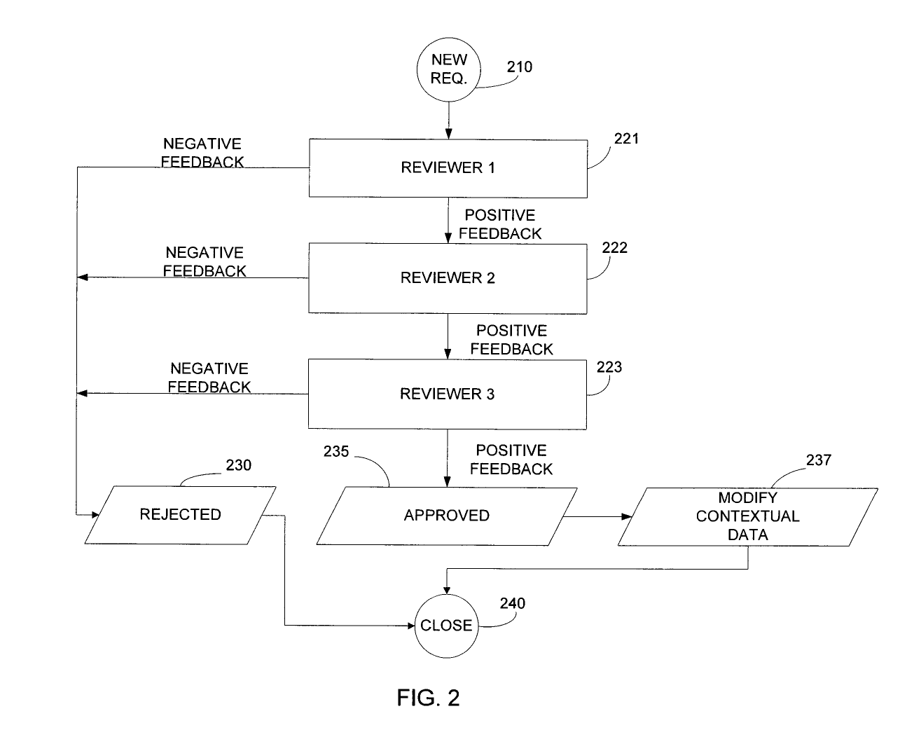

In some embodiments, the web-based interface 150 collects and consolidates the feedback from the reviewers 161-163 for evaluation in order to determine whether the request 101 should be approved or rejected. The web-based interface 150 may evaluate the feedback according to a predetermined workflow. For example, the workflow may dictate which set of reviewers is responsible to inspect and acknowledge requests. Details of one embodiment of a workflow to evaluate feedback from reviewers are discussed below with reference to FIG. 2. Based on result of the evaluation of the feedback, the web based interface 150 may tag the programming interface 104 as requested, store a copy of the programming interface whose contextual data has been modified 130 in the data store 140, and close the request 101 on the defect tracking store 120. In addition, the web based interface 150 forwards the feedback from the reviewers 161-163 to the defect tracking store 120, which may record the feedback. In some alternate embodiments, the defect tracking store 120 may further evaluate the feedback to decide the appropriate actions to be taken.

FIG. 2 illustrates a workflow diagram of one embodiment of a method to review contextual data change requests. The method may be performed by processing logic that may comprise hardware (e.g., circuitry, dedicated logic, programmable logic, microcode, etc.), software (such as instructions run on a processing device), firmware, or a combination thereof.

In some embodiments, the workflow starts with a new request 210 to modify contextual data of a programming interface being pulled from a defect tracking store. In the current example, there are three reviewers (i.e., reviewer 1, reviewer 2, and reviewer 3) to review the request 210. Feedback from the reviewers may be collected sequentially. For example, a graphical user interface (e.g., a webpage) with user interface control (e.g., buttons, checkbox, text fields, etc.) may be provided to the reviewers to enter their feedback. At block 221, feedback is collected from reviewer 1 on the request 210. If reviewer 1 provides positive feedback, then the workflow transitions to block 222. Otherwise, if reviewer 1 provides negative feedback, then the workflow transitions to block 230, where the request 210 is rejected. At block 222, feedback from reviewer 2 is collected. If reviewer 2 provides positive feedback, then the workflow transitions to block 223. Otherwise, if reviewer 2 provides negative feedback, then the workflow transitions to block 230, where the request 210 is rejected. Finally, feedback from reviewer 3 is collected at block 223. If reviewer 3 provides positive feedback, then the workflow transitions to block 235. Otherwise, if reviewer 3 provides negative feedback, then the workflow transitions to block 230, where the request 210 is rejected. In other words, the workflow transitions to block 235 if all three reviewers provide positive feedback on the request 210.

At block 235, the request 210 to modify contextual data of the programming interface is approved, and the workflow then transitions into block 237 to modify the contextual data of the programming interface. If at least one of the reviewers provides negative feedback on the request 210, then the workflow transitions into block 230 to reject the request 210. Finally, the workflow transitions from either block 230 or block 237 into block 240 to close the request 210.

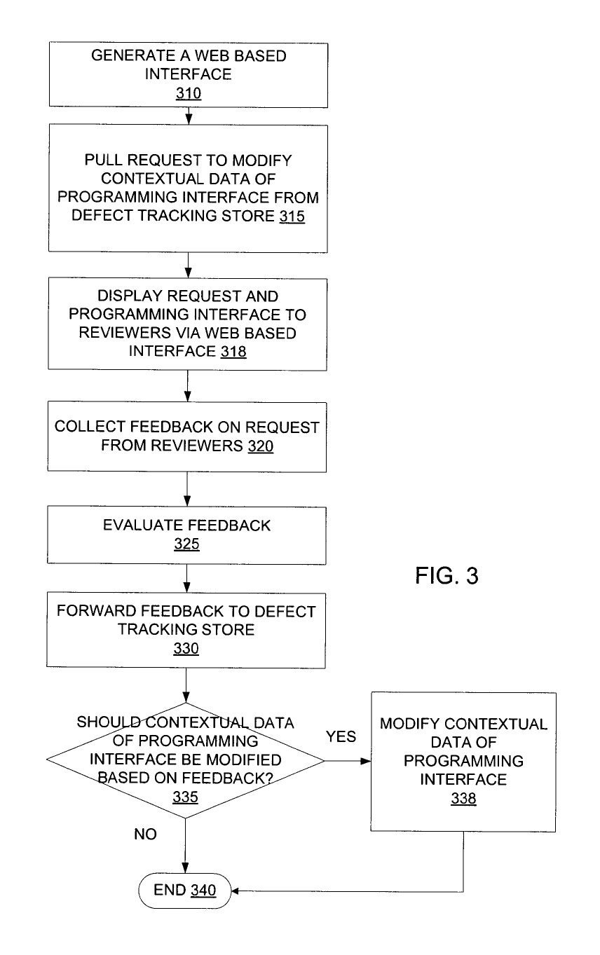

FIG. 3 illustrates a flow diagram of one embodiment of a method to provide an interface between reviewers and a defect tracking store. The method may be performed by processing logic that may comprise hardware (e.g., circuitry, dedicated logic, programmable logic, microcode, etc.), software (such as instructions run on a processing device), firmware, or a combination thereof.

Initially, processing logic generates a web-based interface (processing block 310). The web-based interface may include a webpage allowing reviewers to log in and another webpage to display a set of pending or open requests to modify contextual data of programming interfaces. A user may select, via the web-based interface, one of the pending requests to review. Then processing logic may pull the request from a defect tracking store (processing block 315) and display the request and the associated programming interface on the web based user interface (processing block 318). Then processing logic can collect feedback on the request from reviewers via the web-based interface (processing block 320) and evaluate the feedback collected (processing block 325). Furthermore, processing logic may forward the feedback collected to the defect tracking store (processing block 330).

In some embodiments, processing logic determines if the contextual data of the programming interface should be modified based on the feedback collected (processing block 335). If processing logic determines that the contextual data should be modified, then processing logic modifies the contextual data (processing block 338) and then the process ends at processing block 340. Otherwise, the process ends at processing block 340.

FIG. 4 illustrates one embodiment of a server 400 usable to implement a reviewer tool to review requests to modify contextual data of programming interfaces according to some embodiments of the invention. The server 400 includes a processing device 410, a storage device 420, a network interface 430, a display device 440, and an input device 450, which are coupled to each other via a bus system 460. Note that in different embodiments, the server 400 may include additional components not shown in FIG. 4.

In some embodiments, the storage device 420 stores a set of programming interfaces 423. The storage device 420 may be implemented with a computer-readable storage medium. Note that the term “computer-readable storage medium” should be taken to include a single medium or multiple media (e.g., a centralized or distributed database, and/or associated caches and servers) that store the programming interfaces 423. The term “computer-readable storage medium” shall also be taken to include any medium that is capable of storing, encoding or carrying a set of instructions for execution by the machine and that cause the machine to perform any one or more of the methodologies of the present invention. The term “computer-readable storage medium” shall accordingly be taken to include, but not be limited to, solid-state memories, optical and magnetic media, etc.

In some embodiments, the processing device includes one or more general-purpose processing devices, such as a microprocessing device, a central processing unit, or the like. More particularly, the processing device may be complex instruction set computing (CISC) microprocessing device, reduced instruction set computing (RISC) microprocessing device, very long instruction word (VLIW) microprocessing device, or processing device implementing other instruction sets, or processing devices implementing a combination of instruction sets. The processing device 410 may also be one or more special-purpose processing devices, such as an application specific integrated circuit (ASIC), a field programmable gate array (FPGA), a digital signal processing device (DSP), network processing device, or the like. The processing device 410 may pull the request to modify the contextual data of one of the programming interface from a defect tracking store, which may be local to the server 400 or external to the server 400. In the case where the defect tracking store is external to the server 400 (e.g., the defect tracking store running on another server communicably coupled to the server 400), the processing device 410 may pull the request via the network interface 430 over a network, which may include the Internet, a local area network (LAN), an Ethernet, etc.

After pulling the request from the defect tracking store, the processing device 410 may execute a contextual data change request reviewer tool 415 to generate a user interface to collect feedback from a group of reviewers on the programming interface, consolidate the feedback collected to evaluate the feedback, and determine whether to grant the request to modify the contextual data of the programming interface based on the feedback. The user interface generated may include a web-based graphical user interface. In some embodiments, the web-based graphical user interface may be transmitted via the network interface 430 over a network (e.g., the Internet) to another computing machine (e.g., a desktop personal computer, a laptop computer, a PDA, etc.) to be rendered thereon. Thus, reviewers may review the request using multiple computing machines at different remote locations.

In some embodiments, the server 400 includes a display device 440 (e.g., a liquid crystal display (LCD) or a cathode ray tube (CRT)) to display the programming interface to the reviewers via the user interface generated. The user interface may further include user interface control (e.g., buttons, checkboxes, scrollbars, drop-down menu, etc.) to receive user inputs from the reviewers. Furthermore, the server 400 may include one or more physical input devices 450 to allow reviewers to input their feedback on the request. The input device 450 may include an alphanumeric input device (e.g., a keyboard), a touch screen, a voice input device (e.g., a microphone), and/or a cursor control device (e.g., a mouse), etc.

Thus, some embodiments of a system and a method to review requests to modify contextual data of programming interface have been described. It is to be understood that the above description is intended to be illustrative, and not restrictive. Many other embodiments will be apparent to those of skill in the art upon reading and understanding the above description. The scope of the invention should, therefore, be determined with reference to the appended claims, along with the full scope of equivalents to which such claims are entitled.

What is claimed is:

1. A computer-implemented method, comprising:
generating, by a processing device, a user interface to collect feedback from a plurality of reviewers on a programming interface in response to a request to modify contextual data of the programming interface;
consolidating, by the processing device, the feedback collected to evaluate the feedback; and
determining, by the processing device, whether to modify the contextual data of the programming interface based on the feedback.

2. The method of claim 1, further comprising:
pulling, by the processing device, the request to modify the contextual data of the programming interface from a defect tracking store, which has received the request from a user of the programming interface.

3. The method of claim 1, further comprising:
evaluating, by the processing device, the feedback from the plurality of reviewers; and
rejecting, by the processing device, the request if the feedback from at least one of the plurality of reviewers is negative.

4. The method of claim 1, further comprising:
evaluating, by the processing device, the feedback from the plurality of reviewers; and
approving, by the processing device, the request if the feedback from all of the plurality of reviewers is positive.

5. The method of claim 1, further comprising:
forwarding, by the processing device, the feedback collected from the plurality of reviewers to the defect tracking store.

6. The method of claim 1, further comprising:
displaying the programming interface to the reviewers via the user interface.

7. The method of claim 1, wherein the user interface comprises a web-based graphical user interface.

8. An apparatus comprising:
a storage device to store a plurality of programming interfaces; and
a processing device coupled to the storage device, to generate a user interface to collect feedback from a plurality of reviewers on a programming interface in response to a request to modify contextual data of the programming interface, to consolidate the feedback collected to evaluate the feedback, and to determine whether to modify the contextual data of the programming interface based on the feedback.

9. The apparatus of claim 8, wherein the processing device pulls the request to modify the contextual data of the programming interface from a defect tracking store, which has received the request from a user of the programming interface.

10. The apparatus of claim 8, wherein the processing device evaluates the feedback from the plurality of reviewers, and rejects the request if the feedback from at least one of the plurality of reviewers is negative.

11. The apparatus of claim 8, wherein the processing device evaluates the feedback from the plurality of reviewers, and approves the request if the feedback from all of the plurality of reviewers is positive.

12. The apparatus of claim 8, wherein the processing device forwards the feedback collected from the plurality of reviewers to the defect tracking store.

13. The apparatus of claim 8, further comprising a display device to display the programming interface to the reviewers via the user interface.

14. The apparatus of claim 8, wherein the user interface comprises a web-based graphical user interface.

15. A system comprising the apparatus of claim 8, further comprising:
a server to run a defect tracking store to receive the request from a user.

16. The system of claim 15, further comprising:
a computing machine having a display device, communicably coupled to the processing device, wherein the processing device sends the user interface generated to the computing machine to be rendered on the display device of the computing machine.

17. A computer-readable storage medium embodying instructions that, when executed by a processing device, will cause the processing device to perform a method comprising:
generating a user interface to collect feedback from a plurality of reviewers on a programming interface in response to a request to modify contextual data of the programming interface;
consolidating the feedback collected to evaluate the feedback; and
determining whether to modify the contextual data of the programming interface based on the feedback.

18. The computer-readable storage medium of claim 17, wherein the method further comprises:
pulling the request to modify the contextual data of the programming interface from a defect tracking store, which has received the request from a user of the programming interface.

19. The computer-readable storage medium of claim 17, wherein the method further comprises:
evaluating the feedback from the plurality of reviewers; and
rejecting the request if the feedback from at least one of the plurality of reviewers is negative.

20. The computer-readable storage medium of claim 17, wherein the method further comprises:
evaluating the feedback from the plurality of reviewers; and
approving the request if the feedback from all of the plurality of reviewers is positive.

21. The computer-readable storage medium of claim 17, wherein the method further comprises:
forwarding the feedback collected from the plurality of reviewers to the defect tracking store.

22. The computer-readable storage medium of claim 17, wherein the method further comprises:
displaying the programming interface to the reviewers via the user interface.

23. The computer-readable storage medium of claim 17, wherein the user interface comprises a web-based graphical user interface.
